(19) United States
(12) Patent Application Publication
(10) Pub. No.: US 2016/0046055 A1
(43) Pub. Date: Feb. 18, 2016

(54) PLASTICIZING UNIT FOR AN INJECTION MOLDING MACHINE

(71) Applicant: ENGEL AUSTRIA GmbH, Schwertberg (AT)

(72) Inventor: Bernhard PRAHER, Linz (AT)

(21) Appl. No.: 14/825,599

(22) Filed: Aug. 13, 2015

(30) Foreign Application Priority Data
Aug. 14, 2014 (AT) 639/2014

(51) Int. Cl. B29C 45/78; G01K 11/22; G01K 13/02; B29C 45/47

(52) U.S. Cl. CPC B29C 45/78; B29C 45/47; G01K 11/22; G01K 13/02; B29C 2945/7604; B29C 2945/76193; B29C 2945/76381; B29C 2945/76474

(57) ABSTRACT

A plasticizing unit (1) for an injection molding machine having a plasticizing screw (4) arranged rotatably and displaceably in a cylinder bore of an axially extending plasticizing cylinder, wherein a screw prechamber (3) is arranged between an injection nozzle of the plasticizing cylinder and a screw tip of the plasticizing screw (4), wherein a plurality of ultrasound transducers (5) is arranged at different axial positions of a wall (2) of the plasticizing cylinder and there is provided an evaluation unit (8) which is adapted to produce an axial temperature profile in the screw prechamber (3) from signals from the ultrasound transducers (5).

### BACKGROUND OF THE INVENTION

The present invention concerns a plasticizing unit for an injection molding machine having the features of the classifying portion of claim 1 and a method having the features of the classifying portion of claim 7.

AT 512 647 B1 to the present applicant discloses a method of ascertaining a radial temperature profile in a plasticizing cylinder of a plasticizing unit of the general kind set forth. The method uses the principle of transit time measurement of ultrasound signals. The following are further known:
The use of contact thermometers which are used in wall-connected relationship with the wall of the plasticizing cylinder. For fitting the contact thermometers sensor bores are required on the wall of the plasticizing cylinder. High mechanical loadings occur for the temperature sensors due to the high pressures. Accordingly such sensors are to be of a very sturdy design. That robust casing leads to very long response times, which in turn causes difficulty with dynamic regulation in the metering feed or makes same impossible. A further disadvantage of the wall-connected contact thermometers is the fact that only the temperature at the edge of the plastic melt can be measured.
The use of infrared thermometers which are used in wall-connected relationship in a wall of the plasticizing cylinder. Sensor bores are necessary on the plasticizing cylinder for mounting the contact thermometers. The response times are markedly better than in the case of contact thermometers, but here too only the melt temperature is measured at the edge (depending on the respective type of plastic and depth of penetration of the infrared radiation typically 1-8 mm). In addition errors can occur due to dispersion and reflection of the infrared radiation. The emission coefficient of the plastic melt has to be ascertained in a calibration measurement procedure.
Laser-induced fluorescence. Sensor bores are required on the plasticizing cylinder for mounting the optical accesses. Fluorescence dyes added to the plastic are stimulated by way of a laser beam. The resulting fluorescence is passed into a spectrometer by way of a confocal arrangement by way of a light guide. Evaluation of the (temperature-dependent) fluorescence spectra makes it possible to calculate back to the temperature in the focus region of the laser beam. Averaging of the radial temperature measurement can be implemented by means of the laser-induced fluorescence (if the plastic melt is transparent to the laser radiation and the fluorescence radiation), by the focus position of the laser being varied in the plastic melt. The overall instrumentation (laser, spectrometer, optical accesses) is very tedious and ongoing use in an industrial environment is to be classified as critical.

The plasticizing operation can involve temperature fluctuations in the plasticizing cylinder, which detrimentally influence the quality of the plasticized melt.

### SUMMARY OF THE INVENTION

The object of the invention is to provide a plasticizing unit of an injection molding machine, in which temperature fluctuations influencing the quality of the plasticized melt can be detected, as well as the provision of a corresponding method.

Advantageous embodiments are defined in the appendant claims.

The unwanted fluctuations in the product quality of injection-molded plastic components are to be attributed in particular to detrimental axial temperature profiles (temperature gradients) in the plasticized melt as they are generally much higher than the radial temperature profiles. The axial temperature profiles occur due to the reduction in the effective screw length in the metering feed of the plastic melt into the screw prechamber. To permit active open-loop or closed-loop control of the melt temperature in the metering feed (for example by means of dynamic pressure and/or speed of rotation of the screw), measurement of the axial melt temperature is necessary. The invention permits that in a simple fashion.

Advantages of the invention:
No bores through the wall of the plasticizing cylinder for the ultrasound transducers are necessary.
The temperature of the plastic melt is averaged over the entire diameter of the cylinder bore (not just at the edge).
The invention permits very fast response times.
In itself no calibration is necessary: measurement of the speed of sound at various positions is sufficient to detect axial temperature differences. That is to be attributed to the approximately constant pressure in the screw prechamber in the metering feed.

### BRIEF DESCRIPTION OF THE DRAWINGS

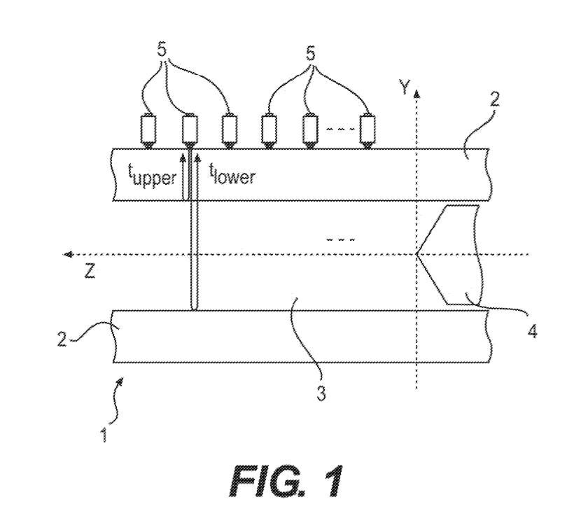

The invention is discussed in detail for various embodiments with reference to FIGS. 1 through 3, each of which being a partial schematic diagram of the plasticizing unit of the present invention.

### DETAILED DESCRIPTION OF THE INVENTION

The Figures show a portion of a plasticizing unit 1 for an injection molding machine in the form of a rotatable plasticizing screw 4 arranged displaceably in a cylinder bore of a plasticizing cylinder (with wall 2). The plasticizing screw 4 is moved away from the injection nozzle by the metering feed of plasticized plastic material in the region between the injection nozzle (not shown) and the tip of the plasticizing screw 4 (screw prechamber 3). In that case a so-called mass cushion is formed in the screw prechamber 3.

If an ultrasound pulse is sent through a plastic melt along a sound transit path S (between an ultrasound transmitter and an ultrasound receiver) the transit time tₜᵣₐₙₛᵢₜ of the pulse through the melt derives from the formula:

$${t}_{transit} = {\int }_{S} \frac{d s}{{c}_{L , s} ( p , T )}$$

wherein c_{L,S}(p,T) denotes the longitudinal speed of sound which is dependent on the pressure p and the temperature T at a position s along the sound transit path S.

If the longitudinal speed of sound c_{L} is known as the function of the pressure p and the temperature T (by calibration measurement or preferably by looking up tables known to the man skilled in the art , which give the transit time of sound for various plastics—that is possible because at least approximately a constant pressure obtains in the screw prechamber in the metering operation), it is possible to arrive at the mean temperature along the sound transit path S from the transit time measurement.

Ultrasound transit time measurements are carried out at a plurality of axial positions for measuring the axial temperature distribution in the screw prechamber 3. The measurements can be performed by means of so-called reflection or transmission measurements.

Reflection measurement is shown in FIG. 1. Axial measurement of the melt chamber is effected in the screw prechamber 3.

An ultrasound transducer array with a plurality of ultrasound transducers 5 is disposed along the screw prechamber 3 at the wall 2 of the plasticizing cylinder. Alternatively measurement can also be implemented with an ultrasound transducer 5 alternately at different axial positions over a plurality of injection molding cycles.

An ultrasound pulse which is passed into the plasticizing cylinder is reflected at the upper edge of the cylinder bore. A part of the sound energy further passes through the plasticized plastic melt, is reflected at the lower edge of the cylinder bore and goes back to the ultrasound transducer. The speed of sound (at the dynamic pressure p_{dynamic} during the metering feed) and thus the mean melt temperature Tₘ along the sound transit path can be inferred from the difference in the transit times of reflections at the upper and lower edges (tᵤₚₚₑᵣ and t_{lower}) of the cylinder bore and the known diameter of the cylinder bore d_{cylinder}:

$${c}_{L} ( p = {p}_{dynamic} , {T}_{m} ) = \frac{2 {d}_{cylinder}}{{t}_{upper} - {t}_{lower}}$$

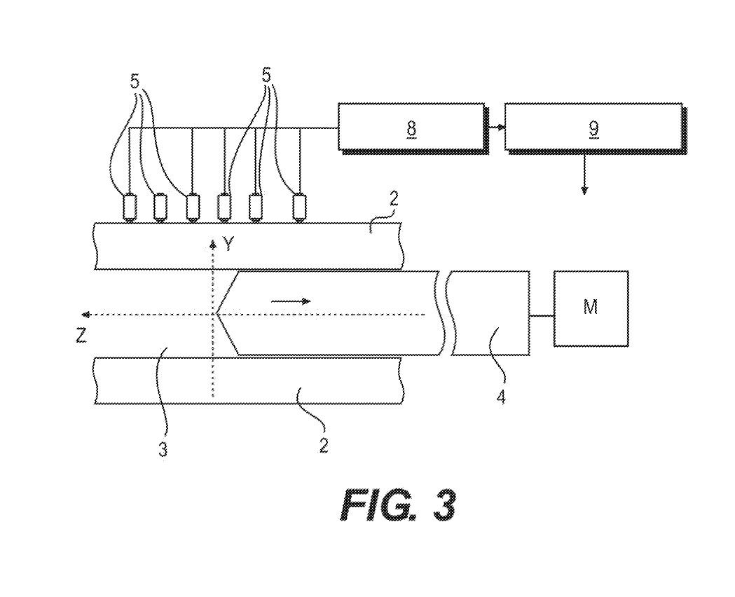

Measurement at various axial positions gives an axial temperature profile in the screw prechamber 3. Calculation is effected in an evaluation unit 8 shown in FIG. 3.

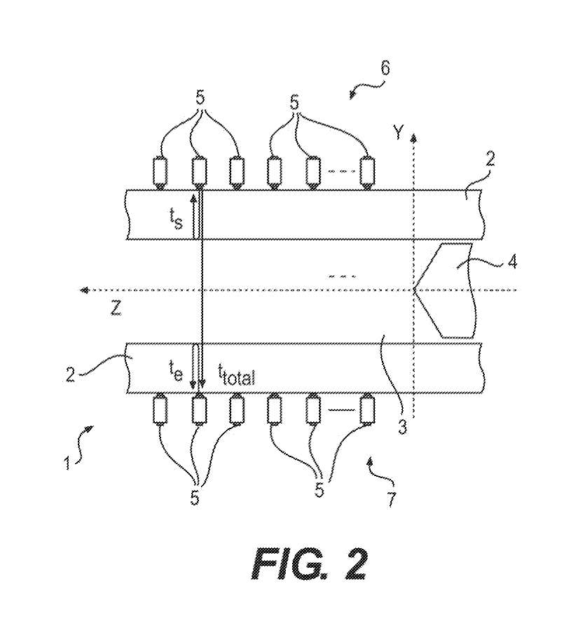

In transmission measurement, shown in FIG. 2, two mutually opposite ultrasound transducer arrays 6, 7 with ultrasound transducers 5 are mounted at different axial positions along the screw prechamber 3 at the wall 2 of the plasticizing cylinder, wherein the one ultrasound transducer array is used as a transmitter array 6 and the opposite ultrasound transducer array is used as a receiver array 7. Alternatively it is also possible to measure with two ultrasound transducers 5 (transmitter and receiver) alternately at various axial positions over a plurality of injection molding cycles.

An ultrasound pulse passed from an ultrasound transducer 5 of the transmitter array 6 into the plasticizing cylinder passes through the first half of the wall 2 of the plasticizing cylinder, further through the plastic melt and thereafter through the second half of the wall 2 of the plasticizing cylinder to the opposite ultrasound transducer 5 of the receiver array 7. The transit times tₛ, t_{c} through the wall 2 of the tₜₒₜₐₗ, cylinder still have to be deducted from the total transit time measured in that way, of the t ultrasound pulse. Those transit times can be ascertained by reflection measurements by means of the ultrasound transducers 5 in the transmitting and receiving arrays 6 and 7. The speed of sound is deduced from

$${C}_{L} ( p = {p}_{dynamic} , {T}_{m} ) = \frac{{d}_{cylinder}}{{t}_{total} - \frac{{t}_{s}}{2} - \frac{{t}_{e}}{2}}$$

An axial temperature profile in the screw prechamber 3 is afforded by the measurement at various axial positions. Calculation is effected in an evaluation unit 8 shown in FIG. 3.

The measurement of tₑ is relatively tedious. On the assumption that an almost rotationally symmetrical temperature profile prevails in the wall 2 tₑ is approximately equal to tₛ. It is thus possible to dispense with the measurement of tₑ.

The invention can be used to produce a temperature distribution which is advantageous for the injection molding process, in the metering feed.

FIG. 3 shows an arrangement for open-loop or closed-loop control of the melt temperature in the screw prechamber 3 in the metering feed (by way of example for reflection measurements, transmission measurements could also be used).

The start of measurement is effected in the metering feed. As soon as the plasticizing screw 4 pulls back and the sound transit path is thus free at a position a measurement in respect of the speed of sound can be effected at the respective position. An advantage with the arrangement is the fact that the pressure (dynamic pressure) in the screw prechamber 3 is known and is approximately constant and there is no need to directly calculate the pressure- and temperature-dependent melt temperature from the measured speeds of sound.

Just the change in the speed of sound at various axial positions is sufficient to ascertain axial temperature differences (axial temperature gradient). Conversion of the ultrasound transit times into speeds of sound or temperatures is effected in an evaluation unit 8. The calculated speeds of sound or temperature values are used by an open-loop or closed-loop control 9 to influence machine parameters (for example dynamic pressure, preferably the screw speed) by way of a motor M driving the plasticizing screw in such a way that a temperature drop in the screw prechamber 3, by virtue of a reduced screw length of the plasticizing screw 4, can be compensated. That influence is preferably implemented from one cycle to another, that is to say not necessarily during a cycle of the plasticizing unit 1 or the injection molding machine of which the plasticizing unit 1 is a part.

The evaluation unit 8 and the open-loop or closed-loop control unit 9 can be physically jointly provided in one component.

In all embodiments the ultrasound transducers 5 bear against the wall 2 of the plasticizing cylinder and are therefore not disposed in bores in the wall 2, which extend through the wall 2. It would be conceivable for the ultrasound transducers 5 to be arranged sunk in blind bores in the wall 2, for example in the case of space problems with heating bands mounted on the plasticizing cylinder.

Advantageously the ultrasound transducers 5 are pressed against the wall 2 of the plasticizing cylinder, for example by way of magnetic holding means. The application of an ultrasound gel between the ultrasound transducers 5 and the wall 2 is commendable. If passive cooling of the ultrasound transducers 5 by the ambient air is not sufficient it is also possible to provide for active cooling.

1. A plasticizing unit for an injection molding machine having a plasticizing screw arranged rotatably and displaceably in a cylinder bore of an axially extending plasticizing cylinder, wherein a screw prechamber is arranged between an injection nozzle of the plasticizing cylinder and a screw tip of the plasticizing screw, wherein a plurality of ultrasound transducers is arranged at different axial positions of a wall of the plasticizing cylinder and there is provided an evaluation unit which is adapted to produce an axial temperature profile in the screw prechamber from signals from the ultrasound transducers.

2. A plasticizing unit as set forth in claim 1 wherein there is provided a single ultrasound transducer array with ultrasound transducers disposed along the screw prechamber at a side of the wall, wherein the ultrasound transducer array is in the form of a transmitting and receiver array.

3. A plasticizing unit as set forth in claim 1 wherein two mutually opposite ultrasound transducer arrays with ultrasound transducers disposed along the screw prechamber are mounted at the wall of the plasticizing cylinder, wherein an ultrasound transducer array is in the form of a transmitter array and the oppositely disposed ultrasound transducer array is in the form of a receiver array.

4. A plasticizing unit as set forth in claim 1 wherein the ultrasound transducers are pressed against the wall of the plasticizing cylinder—preferably by magnetic holding means.

5. A plasticizing unit as set forth in claim 1 wherein an ultrasound gel is disposed between the ultrasound transducers and the wall.

6. A plasticizing unit as set forth in claim 1 wherein there is provided an open-loop or closed-loop control unit which is connected to the evaluation unit and which is adapted to influence machine parameters of the plasticizing screw—preferably the screw rotary speed—by way of a motor driving the plasticizing screw, in such a way that a temperature drop in the screw prechamber by virtue of a reduced screw length of the plasticizing screw can be compensated.

7. A method of producing a temperature profile in the screw prechamber of a plasticizing unit of an injection molding machine using at least one ultrasound transducer, wherein the plasticizing unit has a plasticizing cylinder having a wall, wherein an axial temperature profile is produced from signals obtained at different axial positions of the wall of the plasticizing cylinder by means of the at least one ultrasound transducer.

8. A method as set forth in claim 7 wherein the signals are obtained at the different axial positions by re-positioning of the at least one ultrasound transducer.

9. A method as set forth in claim 7 wherein the signals are obtained at the different axial positions by a plurality of ultrasound transducers.
